(19) United States
(12) Patent Application Publication
(10) Pub. No.: US 2009/0096215 A1
(43) Pub. Date: Apr. 16, 2009

(54) Generator system and method

(76) Inventor: John DelVecchio, Flushing, NY (US)

Correspondence Address: MCCARTER & ENGLISH, LLP, FOUR GATEWAY CENTER, 100 MULBERRY STREET, NEWARK, NJ, 07102, US

(21) Appl. No.: 11/974,858

(22) Filed: Oct. 16, 2007

(51) Int. Cl. F03B 13/00

(52) U.S. Cl. 290/54

(57) ABSTRACT

Devices, systems and methods for generating power from the flow of current in a river are disclosed. A flap in a folded position advances to the front generator. Current catches the flap and extends the flap to an open position. The open flap catches the current and drives the belt of the rotor. The rotor turns and generates power. The open flap reaches the rear rotor and collapses into a folded position. The belt rotates the closed flap to the front generator.

### FIELD OF THE INVENTION

The present invention relates generally to power generation application, and more particularly to a device and method for harnessing the flow of water to generate power.

### BACKGROUND OF THE INVENTION

Hydro power generation harnesses the power of flowing water through pipes to turn turbines. The turbines may have fins arranged in a prop shape. The water drives the prop shaped fins and rotates the prop which turns a turbine. The turbine than produces the electrical power.

To provide the flow of water rivers may be damned and the flow of water may be redirected through pipes that drive the turbine. The damns may alter or damage wildlife habitat. The damns may also obstruct the migration of fish and animals. The damns may also alter the flow of water for downstream activities as well as result in large concrete structures that may spoil scenic views.

Accordingly, a device, method and system is needed to easily and efficiently utilize water currents for generation of power. In addition, the device, method and system may be needed to prevent or minimize environmental impact and preserve views of nature. In addition, the device, method and system may need to prevent destruction of debris and flooding. In addition, the device, method and system may need to be transportable.

### BRIEF DESCRIPTION OF THE DRAWINGS

The above and other objectives and advantages of the present invention will be apparent upon consideration of the following detailed description, taken in conjunction with the accompanying drawings, in which like reference numbers refer to like parts throughout, and in which:

FIG. 1A is a profile view of the generator plant 100 according to a first exemplary embodiment of the present invention.

FIG. 1A is a top plane view of the generator plant 100 according to the first exemplary embodiment of the present invention.

FIG. 2 is a perspective view of the generator wheel container 200 according to a second exemplary embodiment of the present invention.

FIG. 3 is a flow chart of power generation according to a first exemplary method embodiment 300 of the present invention.

FIG. 4 is a flow chart of the installation according to a second exemplary method embodiment 400 of the present invention.

### DETAILED DESCRIPTION OF THE INVENTION

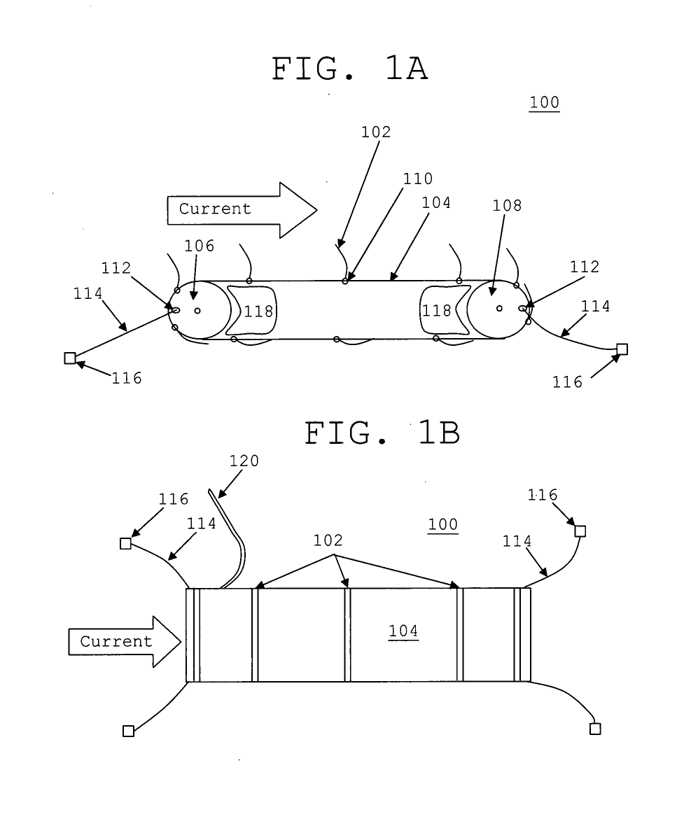

Referring to FIGS. 1A and 1B, a generator plant 100 may be positioned within rivers or a current of water to generate power. The generator plant has several hanged flaps 102 coupled to a belt 104. The flaps 102 catch the flow of water and harness the power of the flowing water to drive the belt 104. The belt 104 drives a front generator 106 and/or a rear generator 108. The front generator 106 and rear generator 108 are described in greater detail later herein.

The generator plant 100 may be positioned in the flow of a river underneath the water's surface. The current (arrow in FIG. 1) catches each flap 102 as it rotates past around the front generator 106. The current rotates each flap 102 from a closed position (as shown by flaps underneath the belt 104) to an open position (as shown by the flaps above the belt 104). The flaps 102 are hanged at hang points 110. The hang points 110 allow the flap 102 to open into an extended position and maximize the force of water on the front surface of the flap 102.

Once the flow of water drives the flap 102 and attached point on the belt 104 to the rear generator 108, the flow of water is blocked by the generator plant 100 and the flap 102 returns to a closed position. The force on successive flaps 102 drives the closed flap forward on the underside of the belt 104. The closed position of the flap 104 reduces the surface area of the flap 102 and minimizes the force required by the belt 104 to advance the closed flap to the beginning of the front of the generator plant 100. Once the flap 102 reaches the front of the generator plant 100, the current once again catches the closed flap 102 and extends the flap 102 to an open position. The current again drives the flap 102 to the rear of the generator plant 100.

The flaps 102 may be designed with a variety of shapes designed to maximize the ability to catch and harness the flow of water. The flaps 102 may be angled to catch the flow and extend longitudinally along the top of the generator plant 100. The exact angle of the cup shape may be designed based on, for example but not limited to the size of the flaps 102, the desired force exerted by the current, and/or number of flaps 102 coupled to the belt 104. The flaps 102 may be made from a variety of materials to provide a rigid or semi-rigid fin. One exemplary construction may have a lower body of the flap 104 made of metal with the outer edges made of a semi-rigid rubber. The semi-rigid portion may allow the flap 102 to catch the force of water, while at the same time, prevent damage from rocks, logs or other debris that may come into contact with the generator plant 100. The semi-rigid portion may also be replaceable after excessive wear and tear.

In another exemplary construction of the flap 102, fingers may extend from the edges of the flap 102. The fingers may also be hanged and designed to minimize the force of water flow to open the flap 102 and/or help to insure the flap 102 opens to an extended position when the flap 102 reaches the front of the generator plant 100. The flap 102 may also incorporate mechanical springs to help the flap 102 rotate from either a closed to an open position or open position to closed position.

The hangs points 110 according to a first exemplary embodiment may be mechanically trigger actuated wherein the current flow swings the flap 102 and hang point 110 to an open position without the use of any mechanical or electrical actuators. The hang points 110 may also incorporate locks that may be triggered remotely to cause the flaps 102 to remain in a closed position. For example, the locks may be used to cause the generator plant to be positioned into protective formation during periods of flood or unpredictable currents. The locks may be triggered to cause the flaps 102 to remain in a closed position as they rotate around the belt 104 to the rear of the generator plant 100. The generator plant 100 may then be positioned at the bottom of the water channel or other locations in order to prevent damage from flood debris or unpredicted currents. Although the exemplary embodiment discloses mechanically triggered flaps 102, the hang points 110 may also incorporate mechanical or electrically driven actuators deriving power from a power source of the generator plant 100 or external to the generator plant 100.

The generator plant 100 may have anchor points 112 for attaching anchor lines 114. The anchor lines 114 may be attached to anchors 116. The anchors 118 may be positioned within the water channel or on the shores of the water channel. The anchors 118 may be, for example but not limited to concrete block, fasteners attached to the bedrock, or other naval vessel anchor types. According to the exemplary embodiment, anchor lines 114 and anchors 116 may be attached to each corner of the generator plant 100. However, a variety of designs may incorporate more or less anchor lines 114 and anchors 106 depending on the size of the generator plant 100 and intended current expected by the generator plant 100.

The generator plant 100 may also have ballasts 118 to aid in the positioning of the generator plant 100 during power generation and during periods of transportation. The exemplary embodiment has two ballasts 118. One may be positioned in the front and one may be positioned in the rear. The ballast 118 may be used not only to adjust the generator plant within the water but may also be used to adjust the angle of the generator plant 100 depending on the flow of current. The ballasts 118 may be externally controlled by pumping in air or water to adjust the buoyancy of the generator plant 100. The ballasts 118 in combination with adjusting the anchor lines 114 and positions of the anchors 116 may be used to position the generator plant. In addition to adjusting the generator plant 100 for power productions, the anchor lines 114 and ballasts 118 may also be used to move the generator plant 100 to a new location or into a protective formation. As previously discussed all the flaps may be positioned into a closed position and anchor lines 114 and ballasts 118 may be used to position the generator plant 100 at the bottom of the channel flow to avoid damage during periods of flood or unusual currents.

A cable 120 may be coupled to the generator plant 100 to supply control communication as well as transfer electrical power to and from the generator plant 100. The cable 120 may be coupled to a control center that regulates the operation and positioning of the generator plant. Power supplied by each generator 106, 108 may be transferred from the generator plant 100 and supplied to a load or grid for consumption. The cable 120 may be used to daisy chain the generator plant 100 to other generator plants within the same stream of current.

The generator plant may be designed in a variety of sizes depending on the intended flow of current. Various applications, for example, may utilize long, narrow flaps. Other designs may include large flaps with relatively short belts. Still other designs may have relatively small flaps with the intent of including multiple generator plants side-by-side strung across a river and daisy chained together.

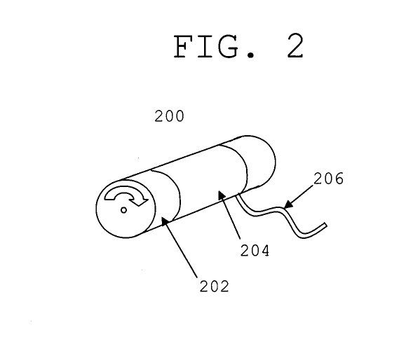

Referring to FIG. 2, each generator plant 100 may include one or more generators 200. The flaps 102 drive the belt 104 which in turn drives a rotor 202. The rotor 202 rotates about a stator 204 and provides alternating electrical feeds used to generate the electrical power. The generator plant 100 may incorporate one generator 200 with a dummy wheel or may incorporate two generators 200 as shown in FIGS. 1A and 1B. The generator plant 100 is not limited to only two generators 200. The generator plant may have more than two generators 200 with additional generators mounted between the front and rear generators and coupled to the belt depending on the design of the generator plant 100. A generator cable 206 may be used to couple the generator to an on board or off board controller as well as daisy-chain it to other generators to transfer power and communicate control signals.

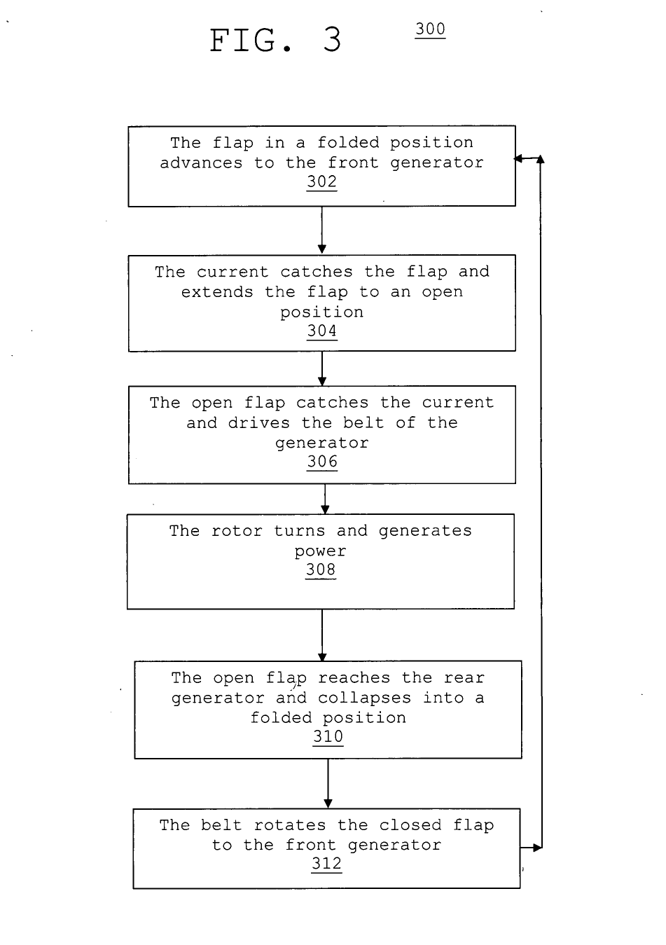

FIG. 3 is a flow chart of power generation according to a first exemplary method embodiment 300 of the present invention. The flap 102 in a folded position advances to the front generator 106 (block 302). The folded position minimizes the force required to advance the flap 102 to the front portion of the generator plant 100. The current catches the flap 102 and extends the flap 104 to an open position (block 304). The open flap 102 catches the current and drives the belt of the generator (block 306). The rotating belt 104 rotates the rotor 202 and generates power (block 308). The open flap 102 reaches the rear generator 108 and collapses into a folded position (block 310). The belt 104 rotates the closed flap 102 to the front generator (block 312) and the process/continues until the current is removed or the generator plant 100 placed into a locked position. The generator plant 100 is not limited to the production of electrical power for external uses. The generator plant 100 may also be used to generate, for example but not limited to, mechanical power, internal power to perform remote functions, for example, relaying communications, feed fish or other remote activities.

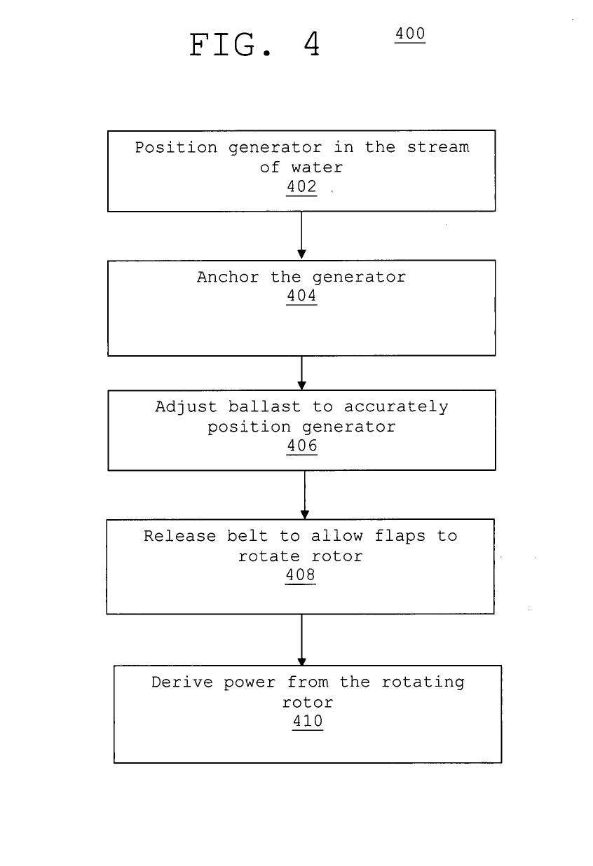

FIG. 4 is a flow chart of the installation according to a second exemplary method embodiment 400 of the present invention. The generator plant 100 may be positioned within the stream of water by a marine vessel, crane, or shore vehicle (block 402). The anchor lines 114 are coupled to anchors 116 as previously described (block 404). The ballasts 118 are adjusted to accurately position the generator (block 406). Once in position, the flaps may be opened and released to provide rotation of the rotors 202 (block 408). Power is delivered from the generator 200 to the load or power grid (block 410)

It will be understood that the foregoing is only illustrative of the principles of the invention and that various modifications can be made by those skilled in the art without departing from the scope and spirit of the invention. For example, the generator plant 100 may rotate in an opposite fashion wherein the flaps 102 rotate in an open position underneath the generator plant 100 and return to the front in a closed position above the generator plant 100. Accordingly, such embodiments will be recognized as within the scope of the present invention. Various aspects disclosed in the exemplary embodiments may be incorporated with aspects disclosed in other exemplary embodiments without departing from the scope of the invention. Persons skilled in the art will also appreciate that the present invention can be practiced by other than the described embodiments, which are presented for purposes of illustration rather than of limitation and that the present invention is limited only by the claims that follow.

What is claimed is:

1. A system for generating power from the flow of water in a river comprising:
a floatable platform; and
a plurality of flaps attached to a belt that rotate about the floatable platform; wherein the belt drives one or more generators to generate power.

2. The system of claim 1, wherein the floatable platform contains one or more inflatable ballasts to raise or lower the platform in the water column.

3. The systems of claim 1, wherein the plurality of flaps are rotatably attached to the belt.

4. The system if claim 1, wherein the rotatable angle for each flap is one of an angle between zero degrees and 180 degrees.

5. The system of claim 1 further comprising fingers attached to and extending from the flaps, wherein the fingers assist in extending the flaps from a closed to an open position.

6. The system of claim 1, wherein the shape of the flaps are concave.

7. The system of claim 1 further comprising one or more anchor means to secure the floatable platform in a substantially fixed position.

8. The system of claim 1 further comprising one or more power transfer cables.

9. A method of generating power from the flow of water in a river comprising the action of:
providing one or more flaps attached to a floatable platform;
using water current to current to extend the one or more flaps and to an open position from the front of the floatable platform to the rear of the floatable platform;
driving a belt of a generator;
turning a rotor to generate electrical energy;
collapsing the one or more flaps into a folded position; and
rotating the closed flap to the rear of the floatable platform to the front of the floatable platform.

10. A method of generating power from the flow of water in a river comprising the action of:
positioning a floatable platform in the current of a river;
anchoring the floatable platform in the river;
adjusting one or more ballasts within the floatable platform;
allowing one or more flaps attached to a rotatable belt to be driven about the floatable platform using the current of the river; and
deriving electrical energy from the rotation of the flaps about the floatable platform.
